(19) United States
(12) Patent Application Publication
(10) Pub. No.: US 2025/0332627 A1
(43) Pub. Date: Oct. 30, 2025

(54) FLOW FORMING OF ADDITIVE MANUFACTURED PRODUCTS

(71) Applicant: Addman Intermediate Holdings, LLC, Fort Myers, FL (US)

(72) Inventor: Youping Gao, Camarillo, CA (US)

(21) Appl. No.: 19/087,921

(22) Filed: Mar. 24, 2025

Related U.S. Application Data
(60) Provisional application No. 63/569,832, filed on Mar. 26, 2024.

(51) Int. Cl. B21D 22/16; B33Y 80/00

(52) U.S. Cl. CPC B21D 22/16; B33Y 80/00

(57) ABSTRACT

A method for elongating an additive manufactured object is achieved through the use of flow forming rollers. A preform is additive manufactured with excess material which is used to elongate the preform on as turning machine, as flow forming rollers apply pressure to the preform as it is turning. A mandrel conforming to the object of the preform is positioned within the interior thereof to ensure that proper conformation is achieved. The present invention has particular utility in the additive manufacturing of aerospace components from high temperature alloys.

### CROSS-REFERENCE TO RELATED APPLICATION

This application is a Completion Application of co-pending U.S. Provisional Patent Application, Ser. No. 63/569,832, filed on Mar. 26, 2024 for “Flow Forming of Additive Manufactured Products” the disclosure of which is hereby incorporated by referenced in its entirety, including the drawings.

### PRIOR ART

As is known to those skilled in the art to which the invention pertains, typically additive manufactured products are prepared by depositing layers of material atop one another wherein the base or bottom layer has a first layer of powder deposited thereon. Thereafter, a second layer is deposited which, due to the temperatures, melts the layer there beneath and merges thereinto. This process is repeated continuously until the desired product is formed. However, as is known to the skilled artisan due to the size limitations of the chamber used to manufacture the products, there is a constraint on the height. Thus, there is a need to provide means and methods for lengthening or heightening such additive manufactured products to accommodate larger objects.

It is this to which the present invention is directed.

### BACKGROUND OF THE INVENTION

The present invention pertains to additive manufacturing. More particularly, the present invention pertains to additive manufacturing of products from high refractory metal powders. Even more particularly, the present invention concerns means and methods for elongating additive manufactured products.

### SUMMARY OF THE INVENTION

Elongated additive manufactured products are obtained by first forming a hollow additive manufactured product in a suitable chamber and during the forming process, depositing excess material along the wall or walls of the object to form a preform.

After this preform is manufactured, at atmospheric conditions, a mandrel is inserted into the interior of the so-manufactured preform and the preform is mounted onto a turning machine. Once mounted on the turning machine, flow forming rollers then engage the walls of the object and as the rollers rotate and compress the preform and traverse the length of the preform, it is thereby elongated.

This flow forming process is typically conducted while the additive manufactured product is maintained at either ambient or elevated temperatures of up to about 800° F.

The present invention is particularly advantageous in elongating objects formed from high temperature refractory alloys.

For a more complete understanding of the present invention, reference is made to the following detailed description and accompanying drawing. In the drawing, like references refer to like parts throughout the several views in which:

### BRIEF DESCRIPTION OF THE DRAWING

FIG. 1 is a side view of an additive manufactured product in accordance with the present invention;

FIG. 2 is a cross-sectional side view of an elongated object created from the flow forming; and

FIG. 3 is a side view of an alternate preform.

### DETAILED DESCRIPTION OF THE INVENTION

Heretofore, as is known to the skilled artisan, additive manufacturing of high temperature alloys is constrained by the size of the additive manufacturing printer. Thus, the manufacture of components, such as aerospace components, formed from high temperature alloys such as Niobium Super C103, or the like, are constrained in size. By flow forming a preform of these high temperature alloys, elongated or longer objects can be produced.

In accordance with the present invention, there is provided a method for elongating an additive manufactured product which, generally, comprises forming a hollow additive manufactured preform in a suitable chamber; depositing excess refractory material during the forming process along the wall(s) thereof; removing the so-manufactured preform product from the additive manufacturing chamber; inserting a mandrel into the interior of the so-manufactured product; mounting the product with the mandrel onto a turning machine and contacting the object with flow forming rollers which rotate the product or object on the turning machine to elongate the object.

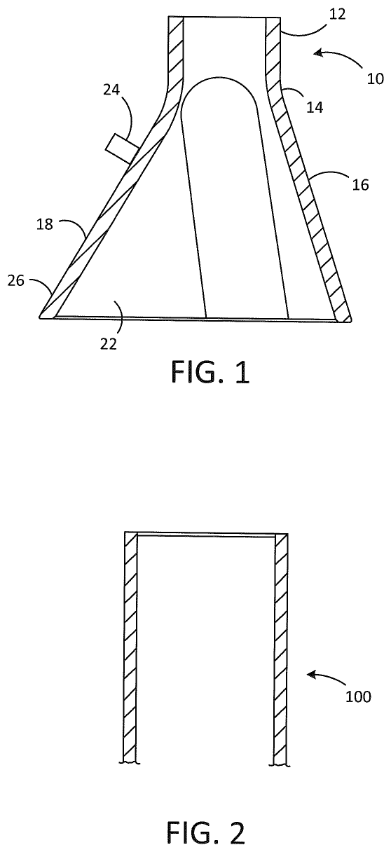

With more particularity and with reference to FIGS. 1 and 2 of the drawing, there is depicted therein a side view of an additive manufactured cylindrical preform product 10 having a neck 12, a reduced diameter medial section 14, an elongated cylindrical main body or sidewall 16 and an internal cavity 22.

The main body sidewall 16 is formed with an excess of material, e.g., a high temperature alloy powder, as at 18 being deposited thereon in accordance with an additive manufacturing process.

Optionally, the sidewall 16 having the excess material may be flared as at 26 to provide the ability of greater elongation of the final form of the product or object to be produced, as is represented as at 100.

Once the preform is produced in the additive manufacturing chamber, the so-manufactured preform is removed therefrom and allowed to cool. A mandrel 20 is then inserted into the interior cavity 22 of the preform. Thereafter, the preform is mounted onto a rotating machine (not shown).

Flow forming rollers 24 (only one of which is shown) engage the sidewall 16 and traverse the length of the sidewall as they rotate around the circumference thereof.

As is known to those skilled in the art to which the present invention pertains, flow forming is a rotary operation performed on a machine tool that closely resembles a traditional woodworking lathe. Flow forming is typically conducted using three rollers, the motion of which is controlled by a CNC machine tool or similar machine.

The flow forming rollers force the material to flow into the desired shape. It starts with a machined, forged or deep drawn tube or cup-shaped “preform” that is much thicker than the thin circular disk that is typically associated in a spin forming operation.

In operation, the preform is placed over the hardened, precision-ground steel mandrel and is firmly clamped to the turning machine having an hydraulic tailstock. The rollers are then engaged, pushing against the now rotating preform from the tailstock and forward toward the spindle. Since the material has nowhere else to go, it gradually gives way before the rollers, thus, elongating as it conforms to the mandrel within the cavity.

The applied pressure from the flow forming rollers causes the excess material to be thinned out thereby elongating the preform, as shown in FIG. 2 at 100.

As noted above, it is also possible to flare the sidewall as at 26. The flare is created as is the entirety of the preform, itself, according to computerized instructions delivered to an additive manufacturing machine from a slicer (not shown). The flared portion is the source of the excess material used to elongate the preform in manufacturing the object sought to be produced.

Once the desired length or configuration is achieved, the mandrel is removed, and a final elongated product is complete.

According to the present invention, 3D or additive manufactured parts formed from these alloys can have greater size imparted to them by manufacturing the preform with excessive material such that there is an excess in thickness of the material used in forming the preform. By flow forming the preform, the excess material can then be used to elongate the preform to provide the final product.

The present process is particularly useful in elongating objects or preforms formed from high temperature refractory alloy metal powders such as niobium, including C-103 alloy, Rhenium, Tantalum and Hafnium for use in aerospace applications.

The present process provides an economical approach o fabricating elongated alloy objects as opposed to welding sections of the object together.

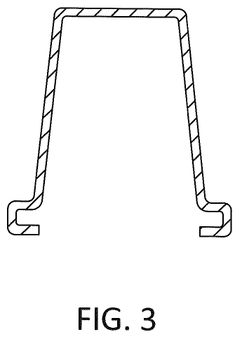

As shown in FIG. 3, in lieu of or in conjunction with the excess material being deposited along the sidewall 16, a shoulder 28 of excess material may be provided at the end of the sidewall in creating the preform. The rollers then engage the shoulder to elongate the preform in the same manner as detailed above.

It should be noted that typically, flow forming processing is conducted at ambient or room temperature. According to the present invention, the preform formed hereby may be heated or warmed below its melting point, i.e., less than about 800° F. during the flow forming to facilitate the elongation of the object.

Also, as known to the skilled artisan, it is possible to mount the preform to the turning machine without the mandrel and alternate means are used to secure the preform to a tailstock.

1. A method for elongating a hollow object, comprising:
a) additive manufacturing a hollow object from a high temperature refractory alloy;
b) depositing excess alloy material on the exterior of the object to create a preform having an opening;
c) removably mounting the preform on a turning machine; and
d) contacting the object with flow forming rollers as the object is turned to elongate the object.

2. The method of claim 1 which further comprises:
inserting a mandrel through the opening prior to turning the preform.

3. The method of claim 2 wherein:
the preform is a substantially cylindrical preform, the mandrel being conformed to the shape of the preform.

4. The method of claim 3 wherein:
the preform is a frusto-conical preform.

5. The method of claim 4 wherein:
the preform includes a shoulder at one end, the shoulder defining the excess material.

6. The method of claim 1 wherein the refractory alloy is a niobium alloy.

7. The method of claim 1 wherein the preform is elongated at a temperature ranging between ambient up to about 800° F.
